(19) United States
(12) Patent Application Publication
(10) Pub. No.: US 2007/0199662 A1
(43) Pub. Date: Aug. 30, 2007

(54) Bracket assembly for rolling shutter system

(75) Inventor: James V. Miller, Glen Ellyn, IL (US)

Correspondence Address: MCANDREWS HELD & MALLOY, LTD, 500 WEST MADISON STREET, SUITE 3400, CHICAGO, IL, 60661, US

(73) Assignee: Qualitas Manufacturing Inc.

(21) Appl. No.: 11/361,754

(22) Filed: Feb. 24, 2006

(51) Int. Cl. E06B 9/08

(52) U.S. Cl. 160/23.1

(57) ABSTRACT

Embodiments of the present invention provide a bracket for use within a rolling shutter assembly having a rolling shutter coiled around a shutter support. The bracket includes a main body having a pivot member configured to pivotally secure within the shutter assembly, wherein the main body is configured to pivot about the pivot member. A support attachment member is configured to secure to the shutter support, wherein the support attachment member is separate and distinct from the pivot member.

### BACKGROUND OF THE INVENTION

Embodiments of the present invention generally relate to a rolling shutter system, and more particularly to a new and improved bracket assembly for a rolling shutter system.

Rolling shutter systems are used to protect various homes and businesses. Typically, the rolling shutter systems include a shutter housing that contains a flexible shutter that is wrapped around a roller pin or tube. The tube may be rotated to selectively move the shutter between closed and open positions.

FIG. 1 illustrates an isometric view of a conventional shutter system 10. The shutter system 10 is similar to the shutter assemblies shown and described in U.S. Pat. No. 5,975,185, entitled “Pop Up Safety Device For Rolling Shutters,” and U.S. Pat. No. 6,244,325, entitled “Safety Release Clutch For Rolling Shutters,” both of which are hereby incorporated by reference in their entireties.

The shutter system 10 includes a shutter housing 12, and a shutter support 14 mounted for rotation within the shutter housing 12. The shutter support 14 may include a generally cylindrical central roller tube 16 and a plurality of mounting members 18 fixed to the roller tube 16.

An upper end of a rolling shutter 20 is coupled to at least one of the mounting members 18. Optionally, the mounting members 18 may be omitted and the rolling shutter may be mounted directly to the roller tube 16. The shutter 20 may include a plurality of individual, elongate slats 22. The ends of the slats 22 are disposed within a pair of shutter tracks 24. When mounted to protect a window or other opening, the shutter tracks 24 are positioned on either side of the opening and the shutter housing 12 is positioned over the top of the opening. Typically, the shutter assembly 10 includes a tubular electric motor (not shown) disposed within the roller tube 16 that is operable to rotate the roller tube 16 and, therefore, move the shutter 20 between open and closed positions.

FIG. 2 illustrates a side elevation view of the conventional shutter system 10 in which the shutter 20 is in an open position. As shown in FIG. 2, the shutter 20 is wrapped around the shutter support 14 such that the bottom 26 of the shutter 20 is positioned near the top 28 of the tracks 24. In this position, the bottom 26 of the shutter 20 hangs substantially parallel with the tracks 24 and little to no stress is exerted into the portion 30 of the shutter 20 that hangs down from coiled portion 32 of the shutter 20.

FIG. 3 illustrates a side elevation view of the conventional shutter system 10 in which the shutter 20 is in a closed position. As shown in FIG. 3, the shutter 20 is completely uncoiled from the shutter support 14. In this position, a portion 34 of the shutter 20 within the housing 12 is angled with respect to the tracks 24. That is, the shutter 20 is not substantially straight from the bottom 26 to the portion attached to the support member 14. The angle θ between the hanging portion 36 of the shutter 20 and the portion 34 of the shutter 20 stresses the portion 34 of the shutter 20 within the housing 12. The stress exerted into this portion 34 of the shutter 20 may hinder movement of the shutter 20 within the tracks, or even cause the shutter 20 to break or snap.

In order to ensure proper movement of a shutter, and protect against damage to the shutter, some systems include a movable support carriage within the housing that moves the support member, and therefore the coiled shutter, linearly within the housing to minimize the angle θ. That is, as the shutter is uncoiled from the support member, the moveable support carriage linearly moves the support member and the shutter so that the shutter remains substantially straight entering the tracks. Such a system requires a separate motor to move the carriage. As such, such a system increases labor and component costs.

Another effort to minimize the angle θ, is shown in FIGS. 4 and 5. FIG. 4 illustrates a side elevation view of an alternative conventional shutter system 38 in which the shutter 20 is in an open position, while FIG. 5 illustrates a side elevation view of the alternative conventional shutter system 38 in which the shutter 20 is in a closed position. As compared to the shutter system 10 shown in FIGS. 2 and 3, the tracks 40 of the system 38 are moved in closer to the center of the shutter housing 12. Thus, when the shutter 20 is uncoiled from the support member 14, the shutter 20 remains in a relatively straight position, thereby minimizing stress exerted into the shutter 20.

Because the tracks 40 are moved in, however, the tracks 40 are, consequently, moved away from a window opening. As such, the shutter system 38 may not be safely secured around an opening (such as a window, walkway, garage, or the like) of the building. Further, a gap may exist between a frame of a window, garage, or the like and the tracks 40, thereby providing an opening that may be exploited from the outside.

Thus, a need exists for a safe and secure rolling shutter system that is relatively cheap and easy to manufacture. Further, a need exists for a rolling shutter system that minimizes the risks of damage to a rolling shutter and is also inexpensive to manufacture.

### SUMMARY OF THE INVENTION

Certain embodiments of the present invention provide a rolling shutter system that includes a shutter housing, at least one shutter guide track secured to the shutter housing, and a bracket assembly. The shutter housing may include a pair of opposed inwardly-extending posts configured to pivotally secure into pivot holes formed in the bracket assemblies. Optionally, the bracket assembly may include at least one post that is configured to be secured within an opening formed in the shutter housing.

The bracket assembly may include a pair of brackets, a shutter support, and a rolling shutter. Each of the brackets is pivotally secured within the shutter housing. Each bracket includes a main body having a pivot member configured to pivotally secure to the shutter housing. The main body is configured to pivot about the pivot member. Each bracket may include a support attachment member configured to secure to the shutter support, wherein the support attachment member is separate and distinct from the pivot member.

The shutter support may be rotatably secured between the pair of brackets. The shutter support is separate and distinct from the pivot member.

The rolling shutter is secured to the shutter support. Rotation of the shutter support in a first direction causes the rolling shutter to coil around the shutter support, while rotation of the shutter support in a second direction causes the rolling shutter to uncoil from the shutter support and pass into the shutter guide track.

The brackets pivot with respect to the shutter housing when the shutter support rotates in the first and second directions. The rotation of the shutter support moves, that is, coils and uncoils, the rolling shutter between open and closed positions. An entire portion of the rolling shutter hanging down from the shutter support (whether that be only a small portion when a bulk of the shutter is coiled around the shutter support, or a large portion when hardly any of the shutter is coiled around the shutter support) remains straight through the open and closed positions.

Each bracket may also include a rotatable gear having a plurality of spokes extending outwardly therefrom. Further, the shutter housing may also include an end plate having a toothed track, wherein the rotatable gear is configured to move over the toothed track. The shutter support may also include a protuberance configured to engage the plurality of spokes, wherein rotation of the shutter support moves the protuberance into one of the plurality of spokes, thereby causing the gear to incrementally rotate upon a full rotation of the shutter support. Rotation of the gear moves the gear over the toothed track, thereby controlling pivotal movement of each of the pair of brackets with respect to the shutter housing.

### BRIEF DESCRIPTION OF SEVERAL VIEWS OF THE DRAWINGS

FIG. 1 illustrates an isometric view of a conventional shutter system.

FIG. 2 illustrates a side elevation view of a conventional shutter system in which a shutter is in an open position.

FIG. 3 illustrates a side elevation view of a conventional shutter system in which a shutter is in a closed position.

FIG. 4 illustrates a side elevation view of an alternative conventional shutter system in which a shutter is in an open position.

FIG. 5 illustrates a side elevation view of an alternative conventional shutter system in which a shutter is in a closed position.

FIG. 6 illustrates an isometric view of a bracket assembly according to an embodiment of the present invention.

FIG. 7 illustrates a front elevation view of a shutter system including a bracket assembly secured within a shutter housing according to an embodiment of the present invention.

FIG. 8 illustrates a side elevation view of a shutter system in which a shutter is in an open position according to an embodiment of the present invention.

FIG. 9 illustrates a side elevation view of a shutter system in which a shutter is in a closed position according to an embodiment of the present invention.

FIG. 10 illustrates a side elevation view of a bracket according to an embodiment of the present invention.

FIG. 11 illustrates a side elevation view of a bracket according to an embodiment of the present invention.

FIG. 12 illustrates a side elevation view of a bracket according to an embodiment of the present invention.

FIG. 13 illustrates a side elevation view of a gear indexing system according to an embodiment of the present invention.

FIG. 14 illustrates a side elevation view of a bracket assembly installation system according to an embodiment of the present invention.

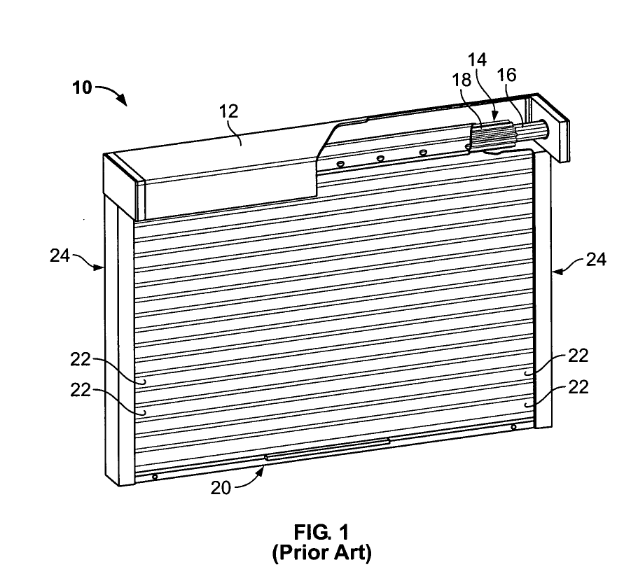

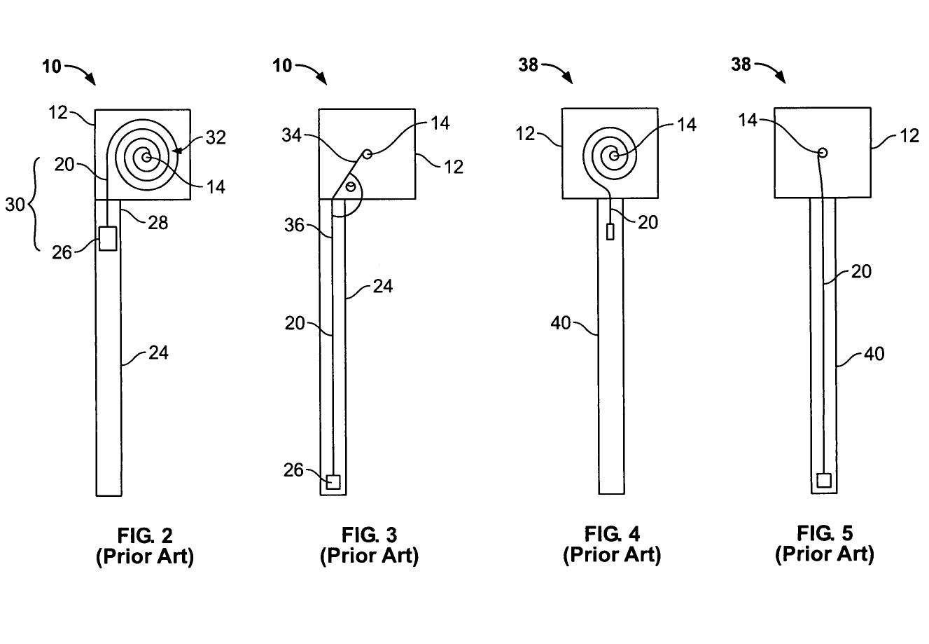

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

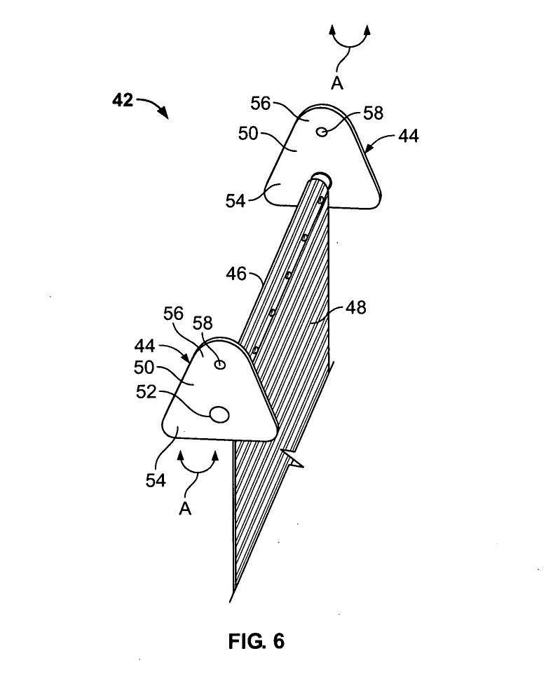

FIG. 6 illustrates an isometric view of a bracket assembly 42 according to an embodiment of the present invention. The bracket assembly 42 includes a pair of brackets 44 supporting a shutter support 46, which may include a roller tube, mounting members, and a motor. A rolling shutter 48 is attached to the shutter support 46. The shutter support 46 is operable to rotate in order to move the shutter 48 between open and closed positions. For example, in the open position, the shutter 48 is coiled around the shutter support 46.

Each bracket 44 includes a main body 50 that may include a support attachment protuberance 52, such as a tab, post, bar, rod, or the like, proximate a lower portion 54 of the main body 50. Optionally, the protuberance 50 may be positioned proximate the center or upper portion 56 of the main body 12. The protuberance 52 is configured to rotatably secure to an end of the shutter support 46. As such, the shutter support 46 may rotate about opposed support attachment protuberances 50.

Alternatively, the main body 50 may not include a support attachment protuberance. Instead, a component, such as a drive or idler may be integrally mounted to the bracket 44.

Each bracket 44 also includes a pivot member 58 formed proximate the upper portion 56 of the main body 50. Optionally, the pivot member 58 may be positioned proximate the center or lower portion 54 of the main body 50. The pivot member 58 may be a hole formed through the main body, as shown in FIG. 6, that is configured to pivotally secure to a post, rod, or the like formed in the interior of a shutter housing (discussed below). Alternatively, the pivot member 58 may be a protuberance that is configured to pivotally secure into a channel, hole, or opening formed in the shutter housing. When pivotally secured within the shutter housing, the pivot members 58 allow the brackets 44 to pivot relative to the shutter housing in the directions of arc A.

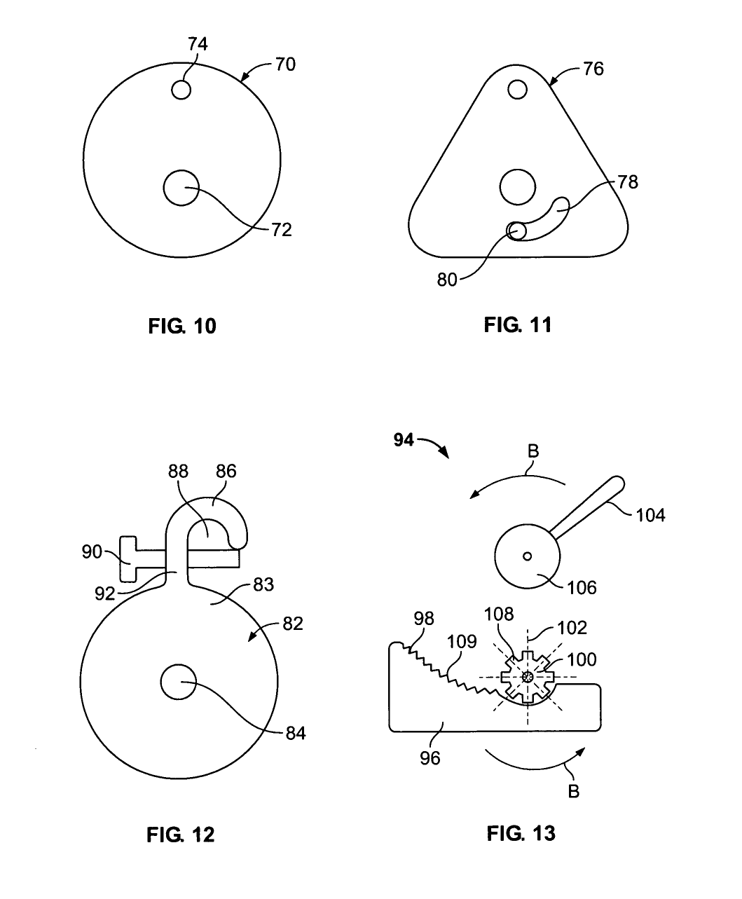

As shown in FIG. 6, the brackets 44 may be shaped in the form of a triangle with rounded edges. This shape may allow proper movement within a shutter housing without the brackets 44 abutting against interior walls of the shutter housing. As shown in FIGS. 10-12, however, the brackets 44 may be formed in various shapes and sizes.

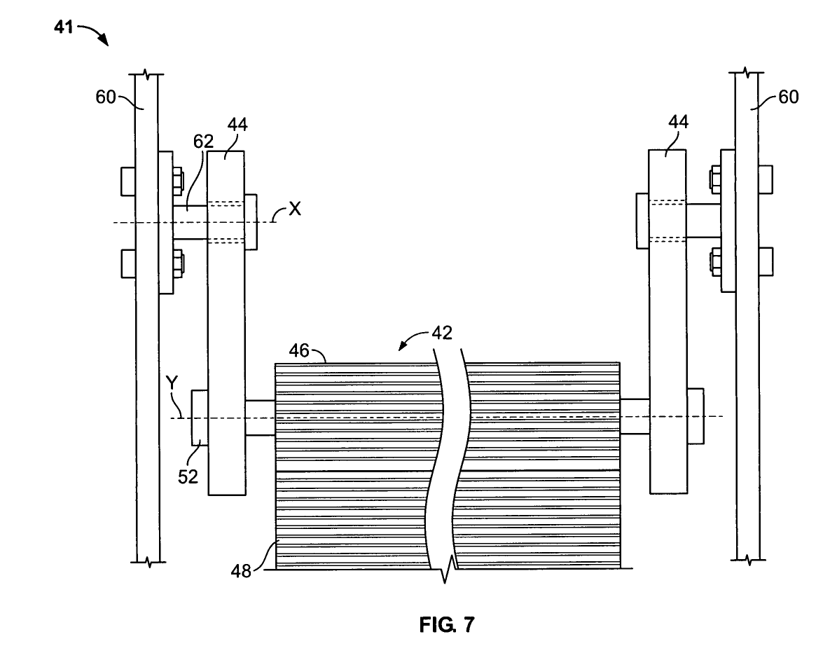

FIG. 7 illustrates a front elevation view of a shutter system 41 including the bracket assembly 42 secured within a shutter housing 60. The brackets 44 may be formed by cutting out portions of the shutter housing 60, thereby reducing the amount of separate materials needed to manufacture the shutter system 41. For example, each bracket 44 may be separately cut from a side wall of the shutter housing 60.

The shutter housing 60 includes securing posts 62 that pivotally secure the shutter housing 60 to the brackets 44 through the pivot members 58. The post 62 rotatably secures within the hole defined by the pivot member 58 so that the bracket 44 may pivot relative to the shutter housing 60 about an axis X that coincides with a longitudinal axis of the post 62. Alternatively, as discussed above, the bracket 44 may include a protuberance, such as a post, that is securely mated into a reciprocal opening formed within the shutter housing 60.

The shutter support 46 is rotatably secured to the protuberances 52 formed proximate the lower portions 54 of the brackets 44. The protuberances 52 may be small knob-like posts, or may, alternatively, be a single rod that connects the brackets 44 together. The shutter support 46 may rotate about a longitudinal axis Y of the protuberances 52 to selectively coil and uncoil the shutter 48 between open and closed positions, respectively.

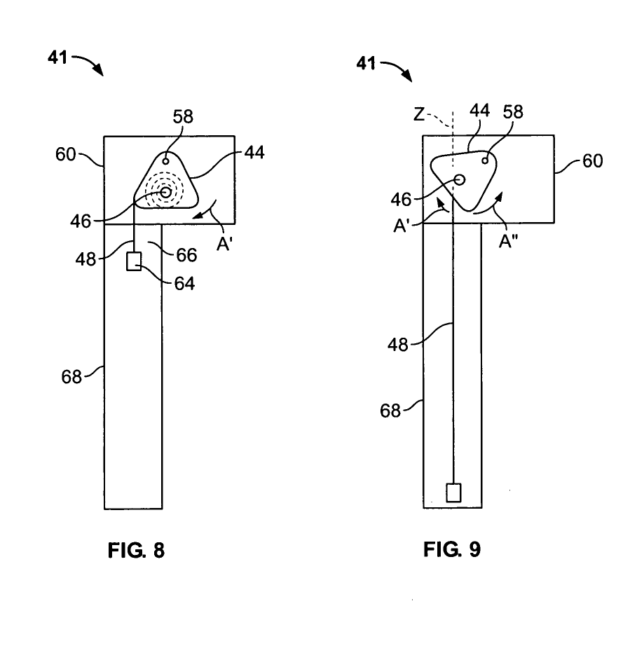

FIG. 8 illustrates a side elevation view of the shutter system 41 in which the shutter 48 is in an open position. In the open position, the bottom 64 of the shutter 48 is proximate the top 66 of the guide tracks 68, while the bulk of the shutter is coiled around the shutter support 46 rotatably secured by the brackets 44. In this position, the weight of the shutter 48 coiled around the shutter support 46 causes the brackets to rest in a substantially vertical position in which the longitudinal axes of the pivot members 58 are vertically positioned over the longitudinal axis of the shutter support 46. In this position, the shutter 48 enters the tracks 68 in a substantially straight line.

As the shutter support 46 begins to rotate to uncoil the shutter 48 into the closed position, the weight of the shutter 48 begins to shift. In particular, the weight of the shutter 48 around the shutter support 46 decreases due to the movement of the shutter 48 toward the lower ends of the tracks 68, while the hanging weight (i.e., that portion no longer coiled around the shutter support 46) of the shutter 48 increases. As the weight of the shutter 48 shifts (i.e., decreasing weight around the shutter support 46 and increasing hanging weight), the brackets 44 begin to pivot about the longitudinal axes of the pivot members 58 in the direction of arc A′. The pivoting movement of the brackets in the direction of arc A′ as the shutter support 46 continues to rotate to uncoil the shutter 48 into the closed position maintains the shutter 48 in a straight line from the shutter support 46 into the tracks 68. That is, the shutter support 46 continually moves in closer alignment with the tracks 68 as the shutter 48 is uncoiled from the shutter support 46.

FIG. 9 illustrates a side elevation view of the shutter system 41 in which the shutter 48 is in a closed position. When the shutter 48 is fully uncoiled from the shutter support 46 so that the shutter 48 is in the closed position, the shutter 48 maintains a straight line from the shutter support 46 into the tracks. As such, the shutter 48 is not stressed, stretched, or strained from the shutter support 46 to the point in which it enters the tracks 68. In this position, the shutter support 46 is no longer vertically aligned with the pivot members 58. Instead, through the pivoting of the brackets 44, the shutter support 46 has shifted toward a vertical plane Z defined by the tracks 68. The pivotal movement of the brackets in this fashion is caused by the shifting weight of the shutter 48 around the shutter support 46, but not by a separate driven carriage. Further, the tracks 48 are fixed around a frame opening.

When the shutter 48 is opened, the shutter support 46 rotates in order to coil the shutter 48 around the shutter support. As the shutter 48 coils around the shutter support 46, the increasing weight of the shutter 48 around the shutter support 46 causes the brackets to pivot about the longitudinal axes of the pivot members 58 in the direction of A″, until the shutter 48 is in an open position, as shown in FIG. 8.

FIG. 10 illustrates a side elevation view of a bracket 70 according to an embodiment of the present invention. The bracket 70 is circular in shape and includes a shutter support attachment member 72 and a pivot member 74.

FIG. 11 illustrates a side elevation view of a bracket 76 according to an embodiment of the present invention. The bracket 76 is similar to the bracket 44 except that the bracket 76 includes an arcuate channel 78 formed through a lower portion. The arcuate channel 78 may slidably retain a protuberance 80 of the shutter housing (not shown in FIG. 11) in order to provide additional stability to the bracket 76 during pivotal movement. As the bracket 76 pivots, the protuberance 80 moves relative to the bracket 76 through the arcuate channel, thereby limiting pivotal movement of the bracket 76.

FIG. 12 illustrates a side elevation view of a bracket 82 according to an embodiment of the present invention. The bracket 82 includes a main body 83 having a shutter support attachment member 84, and a curled stem 86 extending upwardly from the main body 83. The curled stem 86 defines a post channel 88 that is configured to secure around the post 62 (shown in FIG. 7) of the shutter housing 60 (shown in FIG. 7). Once the post 62 is positioned within the post channel 88, a fastener 90 (such as a screw) positioned through a neck 92 of the stem 86 is tightened in order to trap the post 62 within the post channel 88. Thus, the bracket 82 may be pivotally secured to the post 62.

While FIGS. 10-12 show particular shapes and configurations of the brackets, various other shapes, sizes, and configurations may be used.

FIG. 13 illustrates a side elevation view of a gear indexing system 94 according to an embodiment of the present invention. The gear indexing system 94 may include an end plate 96 that may be attached to an interior wall of the shutter housing (not shown in FIG. 3). The end plate 96 includes a toothed track 98 configured to cooperate with a gear 100 rotatably secured to a bracket, such as the bracket 44 shown in FIG. 6. A plurality of spokes 102 extend outwardly from an end of the gear 100.

An actuating bar 104 extends outwardly from a surface of a rotatable shutter support 106, such as a roller tube, proximate an end thereof. Each time the shutter support 106 makes a complete rotation, the actuating bar 104 is actuated into a spoke 102 in the direction of arc B. As the actuation bar 104 contacts the spoke 102, the force exerted by the rotation of the actuation bar 104 causes the spoke 102 to rotate one position in the direction of arc B. The rotation of the spokes 102, in turn, causes the gear 100 to rotate. As the gear rotates, the teeth 108 of the gear 100 mesh with the teeth 109 of the tooted track 98. Rotation of the gear 100 causes the gear to move relative to the end plate 96.

Each end plate 96 is positioned from the axis of rotation of the shutter support 106 such that the toothed track 98 remains at a fixed distance, or radius, from the axis of rotation of the shutter support 106 as the brackets 44 are indexed. That is, the point of contact between the gear 100 and the toothed track 98 and the axis of rotation of the shutter support 106 remains constant through pivotal indexing rotation of the brackets 44.

Each rotation of the shutter support 106 causes the gear to move an incremental position over the toothed track 98. Each full rotation of the shutter support 106 indexes the bracket one position over the toothed track 98. As such, the bracket may securely rest at each incremental position until the actuating bar 104 contacts another spoke 102. A reverse rotation of the shutter support 106 causes a reverse incremental indexing movement of the gear 100 over the toothed track 98.

Indexing the movement of the brackets as discussed above with respect to FIG. 13 ensures that both brackets move in unison with one another. That is, each bracket mirrors the other bracket through full pivotal movement. The gear indexing system 94 allows movement of the brackets to be controlled.

In the example shown, movement over a full pivot range from a shutter open position to a shutter closed position is obtained through eight full rotations of the shutter support 106. However, the gear indexing system 94 may be configured so that full movement may be obtained through more or less rotations of the shutter support 106.

While the end plate 96 is described as being within the shutter housing, the gear indexing system may, alternatively, include the gear and spokes within the shutter housing, while the toothed track is formed on a surface of the bracket. Also, alternatively, the end of the shutter support 106 may include a circumferential toothed surface that cooperates with a gear on the bracket.

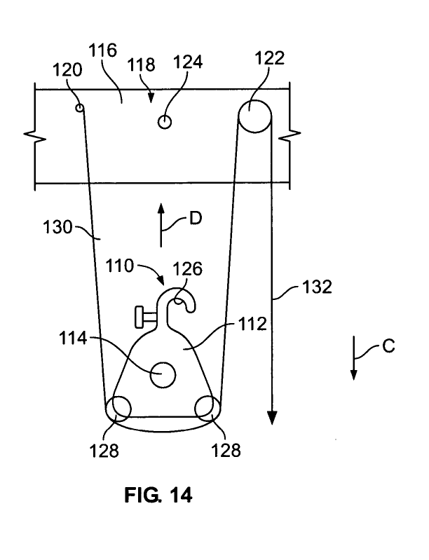

FIG. 14 illustrates a side elevation view of a bracket assembly 110 installation system according to an embodiment of the present invention. The bracket assembly 110 includes a pair of brackets 112 rotatably supporting a shutter support 114, and a shutter (not shown in FIG. 14) coiled around the shutter support 114.

An interior wall 116 of the shutter housing 118 includes an anchor post 120 and a pulley 122. A securing post 124, which is configured to be positioned within a pivot member, such as a pivot channel 126, of the bracket 112, is positioned between the anchor post 120 and the pulley 122.

Pulleys 128 are also positioned proximate a lower portion of each bracket 112. In order to assist in mounting the bracket assembly 110 to the shutter housing 118, a rope 130 is secured to the anchor post 120, fed underneath the pulleys 128 of the bracket 112, an fed over the pulley 122 of the shutter housing 118 (that is, separate ropes 130 may be positioned with respect to both brackets 112). To hoist the bracket assembly 110 up toward the securing post 124, the end 132 of the rope 130 is pulled downwardly in the direction of C. This movement causes the bracket 112, which is supported by the rope 130 underneath the pulleys 128 to lift upward in the direction of arrow D. The pulleys 122 and 128 may include teeth, barbs, clasps, or the like that dig into the rope 130 so that the rope 130 is secured to the pulleys 122 and 128. Additionally, the pulleys 122 and 128 may allow movement in only one direction, so that if a pulling force is no longer exerted to the end 132 of the rope 130, the pulleys 122 and 128 and rope will maintain the bracket 112 at a particular elevation. Once the bracket 112 is move proximate the securing post 124, the bracket 112 is secured to the shutter housing 118 such that the securing post 124 is trapped within the pivot channel 126. After the bracket 112 is secured to the shutter housing 118, the rope 130 may be removed from the anchor post 120 and pulleys 122 and 128. Thus, a heavy bracket assembly 110 may be safely and easily secured to a shutter housing 118.

As shown and discussed above, embodiments of the present invention provide a safe and secure rolling shutter system that is relatively cheap and easy to manufacture and install. Further, embodiments of the present invention provide a rolling shutter system that minimizes the risks of damage to a rolling shutter and is also inexpensive to manufacture. For example, the embodiments discussed above do not require a separate carriage system or motor to ensure that the shutter safely and easily passes into the tracks when being uncoiled from the shutter support system. Additionally, embodiments of the present invention provide a robust construction in which the tracks of the rolling shutter system safely and effectively secure around an opening, such as a window.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A bracket for use within a rolling shutter assembly having a rolling shutter coiled around a shutter support, the bracket comprising:
a main body having a pivot member configured to pivotally secure within the shutter assembly, wherein said main body is configured to pivot about said pivot member; and
a support attachment member configured to secure to the shutter support, wherein said support attachment member is separate and distinct from said pivot member.

2. The bracket of claim 1, wherein said main body is formed as a triangle with rounded edges.

3. The bracket of claim 1, wherein said pivot member is an opening formed through said main body that is configured to pivotally secure around a post of the shutter housing.

4. The bracket of claim 1, wherein said pivot member is a post extending from said main body, wherein said post is configured to be secured within an opening formed in the shutter housing.

5. The bracket of claim 1, wherein said main body comprises a curled stem, and wherein said pivot member comprises a post channel defined by said curled stem.

6. The bracket of claim 1, further comprising a rotatable gear having a plurality of spokes extending outwardly therefrom, said rotatable gear configured to index said main body during pivotal movement of the bracket.

7. The bracket of claim 1, further comprising at least one pulley adapted for installing the bracket to the shutter housing.

8. A rolling shutter system comprising:
a shutter housing;
at least one shutter guide track secured to said shutter housing; and
a bracket assembly comprising:
(i) a pair of brackets pivotally secured within said shutter housing, each of said of brackets comprising a main body having a pivot member configured to pivotally secure to the shutter housing, said main body configured to pivot about said pivot member;
(ii) a shutter support rotatably secured between said pair of brackets, said shutter support being separate and distinct from said pivot member; and
(iii) a rolling shutter secured to said shutter support, wherein rotation of said shutter support in a first direction causes said rolling shutter to coil around said shutter support, and wherein rotation of said shutter support in a second direction causes said rolling shutter to uncoil from said shutter support and pass into said at least one shutter guide track,
said pair of brackets pivoting with respect to said shutter housing when said shutter support rotates to move said rolling shutter between open and closed positions.

9. The rolling shutter system of claim 8, wherein an entire portion of said rolling shutter hanging down from said shutter support remains straight through said open and closed positions.

10. The rolling shutter system of claim 8, wherein each of said pair of brackets comprises a support attachment member configured to secure to said shutter support, wherein said support attachment member is separate and distinct from said pivot member.

11. The rolling shutter system of claim 8, wherein said main body is formed as a triangle with rounded edges.

12. The rolling shutter system of claim 8, wherein said shutter housing further comprises a pair of opposed inwardly-extending posts, and wherein said pivot member is an opening formed through said main body that is configured to pivotally secure around one of said posts.

13. The rolling shutter system of claim 8, wherein said pivot member is a post extending from said main body, wherein said post is configured to be secured within an opening formed in said shutter housing.

14. The rolling shutter system of claim 8, wherein said main body comprises a curled stem, and wherein said pivot member comprises a post channel defined by said curled stem.

15. The rolling shutter system of claim 8, wherein each of said pair of brackets further comprises a rotatable gear having a plurality of spokes extending outwardly therefrom, and wherein said shutter housing further comprises an end plate having a toothed track, wherein said rotatable gear is configured to move over said toothed track.

16. The rolling shutter system of claim 15, wherein said shutter support further comprises a protuberance configured to engage said plurality of spokes, wherein rotation of said shutter support moves said protuberance into one of said plurality of spokes, thereby causing said rotatable gear to incrementally rotate upon a full rotation of said shutter support, wherein rotation of said rotatable gear moves said rotatable gear over said toothed track, thereby controlling pivotal movement of each of said pair of brackets with respect to said shutter housing.

17. The rolling shutter system of claim 8, wherein each of said pair of brackets further comprises at least one pulley, and wherein said shutter housing further comprises an anchor post and a housing pulley, said at least one pulley, said anchor post, and said housing pulley cooperating together when said bracket assembly is installed to said shutter housing.

18. The rolling shutter system of claim 8, wherein said shutter support comprises a roller tube.

19. In a rolling shutter system having a shutter housing, at least one shutter guide track secured to the shutter housing, a bracket assembly comprising:
a pair of brackets each having a pivot member, said pair of brackets pivotally secured within the shutter housing about said pivot members;
a separate and distinct shutter support rotatably secured between said pair of brackets; and
a rolling shutter secured to said shutter support, wherein rotation of said shutter support in a first direction causes said rolling shutter to coil around said shutter support, and wherein rotation of said shutter support in a second direction causes said rolling shutter to uncoil from said shutter support and pass into said at least one shutter guide track,
said pair of brackets pivoting with respect to the shutter housing when said shutter support rotates to move said rolling shutter between open and closed positions.

20. The bracket assembly of claim 19, wherein an entire portion of said rolling shutter hanging down from said shutter support remains straight through said open and closed positions.

21. The bracket assembly of claim 19, wherein each of said pair of brackets comprises a support attachment member configured to secure to said shutter support, wherein said support attachment member is separate and distinct from said pivot member.

22. The bracket assembly of claim 19, wherein each of said pair of brackets is formed as a triangle with rounded edges.

23. The bracket assembly of claim 19, wherein said pivot member is an opening formed through said main body that is configured to pivotally secure around a post extending from the shutter housing.

24. The bracket assembly of claim 19, wherein said pivot member is a post extending from said bracket, wherein said post is configured to be secured within an opening formed in the shutter housing.

25. The bracket assembly of claim 19, wherein each of said pair of brackets comprises a curled stem, and wherein said pivot member comprises a post channel defined by said curled stem.

26. The bracket assembly of claim 19, wherein each of said pair of brackets further comprises a rotatable gear having a plurality of spokes extending outwardly therefrom.

27. The bracket assembly of claim 19, wherein each of said pair of brackets further comprises at least one pulley configured to be used when the bracket assembly is secured to the shutter housing.

28. The bracket assembly of claim 19, wherein said shutter support comprises a roller tube.
